(19) United States
(12) Patent Application Publication
(10) Pub. No.: US 2010/0194860 A1
(43) Pub. Date: Aug. 5, 2010

(54) METHOD OF STEREOSCOPIC 3D IMAGE CAPTURE USING A MOBILE DEVICE, CRADLE OR DONGLE

(75) Inventors: James Mentz, Gainesville, FL (US); Samuel Caldwell, Palm Harbor, FL (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Bit Cauldron Corporation, Gainesville, FL (US)

(21) Appl. No.: 12/699,337

(22) Filed: Feb. 3, 2010

Related U.S. Application Data
(60) Provisional application No. 61/149,651, filed on Feb. 3, 2009.
(60) Provisional application No. 61/149,666, filed on Feb. 3, 2009.

(51) Int. Cl. H04N 13/02

(52) U.S. Cl. 348/47; 348/E13.074

(57) ABSTRACT

A system, apparatus, method, and computer-readable media are provided for the capture of stereoscopic three dimensional (3D) images using multiple cameras or a single camera manipulated to deduce stereoscopic data. According to one method, a dongle or cradle is added to a mobile phone or other device to capture stereoscopic images. According to another method, the images are captured from cameras with oblique orientation such that the images may need to be rotated, cropped, or both to determine the appropriate stereoscopic 3D regions of interest. According to another method, a single camera is manipulated such that stereoscopic 3D information is deduced.

### CROSS-REFERENCES TO RELATED APPLICATIONS

The present patent application claims priority to provisional application Nos. 61/149,651 filed Feb. 3, 2009 and 61/149,666 filed Feb. 3, 2009. The present invention also relates to co-pending U.S. patent application Ser. No. ______ filed Feb. 3, 2010, titled “Method Of Stereoscopic 3D Viewing Using Wireless Or Multiple Protocol Capable Shutter Glasses,” Attorney Docket No.: 028319-000210US. These disclosures are herein by incorporated by reference, for all purposes.

### BACKGROUND OF THE INVENTION

The present invention relates to stereoscopic 3D image acquisition methods and apparatus.

When two-dimensional images that represent left and right points of view are sensed by respective left and right eyes of a user, the user typically experiences the perception of depth from the two-dimensional images. Several systems exist to allow users (e.g. individuals or groups) to perceive stereoscopic 3D depth in images, photos, pictures, moving pictures, videos, or the like, by the projection/reflection of light. Such systems include projectors within a public or home theater; emissive or transmissive displays, such an LCD, plasma display, flat-panel display; or the like. To view such 3D images, a variety of approaches have been provided to the user including prisms, polarized glasses, or the like. A revolutionary approach developed by the inventors to view such images using 3D glasses incorporating radio-frequency synchronization is described in the above-referenced patent application.

With respect to stereoscopic 3D image capture, the inventors have recognized that methods for capturing such images have been limited and have been beyond the reach of the average consumer. The inventors of the present invention recognize that capturing of stereoscopic 3D images currently requires complex 3D imaging hardware and processing software. These systems are typically dedicated to acquiring or generating stereoscopic images. For example, the left and right 2D images that are used to form stereoscopic 3D images are generated entirely by computation (e.g. animation software) or by a pair of professional grade cameras which have been firmly affixed to each other with tightly manufactured proximity and spacing, not necessarily in the prior art. The inventors believe that because current systems provide such narrow and specialized functionality, they are too “expensive” for typical consumers to purchase. The inventors believe that if the cost of 3D hardware and software capturing systems could be reduced, consumers would more readily embrace stereoscopic 3D imaging.

The inventors understand that a number of software products have been developed for particular devices to enable a user to use a single camera to acquire “stereoscopic” images. FIG. 1 illustrates a number of devices 1-3 including cameras 5, 7 and 9, that may or may not exist, that might use such software. For example, device 4 includes an off-center camera 5; device 6 includes centered camera 7, and device 3 includes camera 9. As shown if FIG. 1, portions 10 and 8 of device 3 may be reoriented or repositioned with respect to each other, as shown in dotted positions 11 and 12.

Problems to such approaches, determined by the inventors, include that it requires the user to be very careful how they position the camera to capture two images, one after the other. If the direction in which the camera is pointing is too different between the two images, the images may not overlap, and any three-dimensional stereoscopic effect of the two images may be lost. Another problem, considered by the inventors, is that it requires objects in the scene to be relatively stationary. If objects move to a large degree between the two images, the three-dimensional stereoscopic effect of the two images may also be lost. Yet another problem, believed by the inventors, includes that a user cannot easily receive feedback from such software products, when acquiring certain images. In particular, it is believed that a large number of stereoscopic photographs that users may wish to take using such software will be user self-portraits. However, because single camera devices typically have cameras on the opposite side of the device from the user display, the user's will not be able to view any instructions from the software, while taking such self-portraits. Typical examples of devices where the camera is on the opposite side of the user display includes the Apple iPhone, Motorola Droid, HTC Nexus, and the like.

Accordingly, what is desired are improved methods and apparatus for improved 3D image capture without the drawbacks discussed above.

### BRIEF SUMMARY OF THE INVENTION

Embodiments of the present invention include an imaging device including one or more image sensors (e.g. cameras) and a communications channel. In various embodiments, the imaging device may be physically coupled to a general purpose consumer device such as a personal media player (e.g. iPod), a communications device (e.g. iPhone, Android-based phone), a mobile internet device, a processing device (e.g. netbook, notebook, desktop computers), or the like. Additionally, the imaging device may utilize the communications channel (e.g. Bluetooth, Wi-Fi, ZigBee radio, IR, USB, IEEE 802.15.1, IEEE 802.15.4) to provide image data from the imaging device to the consumer device.

In other embodiments of the present invention, the imaging device may be used independently of the consumer device to acquire stereoscopic images, and such images may be provided to the consumer device via the communications channel. In turn the consumer device may process and/or retransmit the stereoscope images to a remote server. For example, such stereoscopic images may be viewed on the consumer device and/or uploaded to the web (e.g. Facebook, MySpace, TwitPic), sent via e-mail, IM, or the like.

In various embodiments, the imaging device may capture one of the left or right pair of 2D images, and an image sensor on the general purpose consumer device may be used to capture the other 2D image. In other embodiments, the imaging device may include two or more image sensors (e.g. embedded therein) and be used to capture the left and right stereoscopic pair of 2D images. In various embodiments, pair of images are typically captured simultaneously or within a short amount of time apart (e.g. less than 1 second) to facilitate proper 3D image capture. This time period may increase when photographing still life, landscapes, or the like.

In specific embodiments, users (e.g. consumers) may want to capture stereoscopic 3D images using a portable device such as a mobile phone, smart phone, or other device. Embodiments for methods of stereoscopic 3D image capture could incorporate an existing phone or device, a new piece of hardware such as a cradle or dongle for an existing phone or device. Other embodiments may include a piece of software or computer readable method of using an existing or new device to capture stereoscopic 3D images. Still other embodiments may include a system and method that combines these aspects in the capture of stereoscopic 3D images.

It is with respect to these and other considerations that embodiments of systems, methods, apparatus, and computer-readable media are provided for improved image capture of stereoscopic 3D images, photos, pictures, videos, or the like.

Reference to the remaining portions of the specification, including the drawings and claims, will realize other features and advantages of various embodiments of the present invention. Further features and advantages of various embodiments of the present invention, as well as the structure and operation of various embodiments of the present invention, are described in detail below with respect to accompanying drawings.

According to one aspect of the invention, a consumer device for capturing stereoscopic images is disclosed. One apparatus includes a plurality of image acquisition devices, wherein a first image acquisition device and a second image acquisition device are both approximately directed in a common direction, wherein the first image acquisition device and the second image acquisition device are displaced by a displacement, wherein the first image acquisition device is configured to capture a first image, and wherein the second image acquisition device is configured to capture a second image. A system may include a user input device configured to receive an input from a user, a memory configured to store the first image and the second image, and a wired or wireless communications portion configured to transmit data to a remote device. Various devices may include a processor coupled to the first image acquisition device, to the second image acquisition device, to the user input device, and to the communications portion, wherein the processor is configured to approximately contemporaneously direct acquisition of the first image by the first image acquisition device and of the second image by the second image acquisition device in response to the input from the user, wherein the processor is configured direct storage the first image and the second image in the memory, and wherein the processor is configured to direct the communications portion to transmit at least a portion of the first image and at least a portion of the image to a remote device.

According to another aspect of the invention, a method for capturing stereoscopic images, photos or videos on a mobile computing device, wherein the mobile computing device includes at least a first camera and a second camera, and wherein a distance and an orientation between the first and the second cameras are determinable, is disclosed. Techniques may include receiving an initiation signal from a user, while the user points the first and the second cameras in a direction of interest, and substantially simultaneously acquiring a first image with first camera, a second image with a second camera and camera parameters, in response to the initiation signal. One process may include storing the first image, the second image and the camera parameters in a memory, and uploading at least a portion of the first image, at least a portion of the second image, and the camera parameters to a remote server.

### BRIEF DESCRIPTION OF THE DRAWINGS

In order to more fully understand the present invention, reference is made to the accompanying drawings. Understanding that these drawings are not to be considered limitations in the scope of the invention. The presently described embodiments and the presently understood best mode of the invention are described with additional detail through use of the accompanying drawings in which:

FIG. 1 is a diagram illustrating aspects of the prior art;

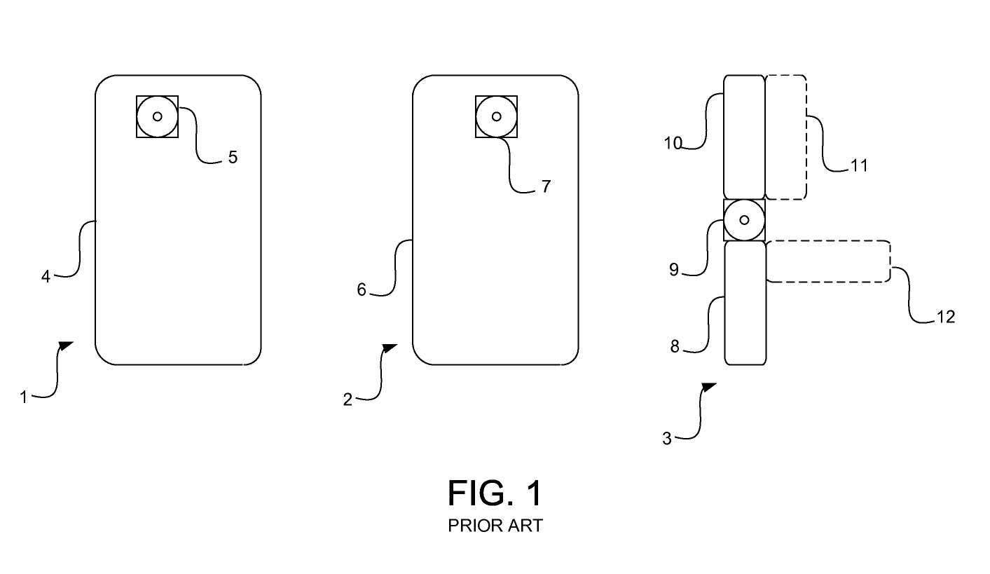

FIG. 2 is a diagram illustrating embodiments of the present invention including methods of incorporating stereoscopic capture capabilities into a mobile device by embedded multiple cameras;

FIG. 3 is a diagram illustrating embodiments of the present invention including methods of incorporating stereoscopic capture capabilities into a mobile phone or other device by attaching an external dongle or fitting the device to a cradle;

FIG. 4 is a diagram illustrating embodiments of the present invention where multiple cameras have been incorporated into a mobile device in which the relative orientation of the cameras can be changed by way of actuating a hinge which is part of the mobile device;

FIG. 5 is a diagram illustrating embodiments of the present invention where the field of view of two cameras changes as a hinge is manipulated; and

FIG. 6 is a diagram illustrating embodiments of the present invention where the field of view of two obliquely oriented cameras are rotated and/or cropped to specific regions of interest.

### DETAILED DESCRIPTION OF THE INVENTION

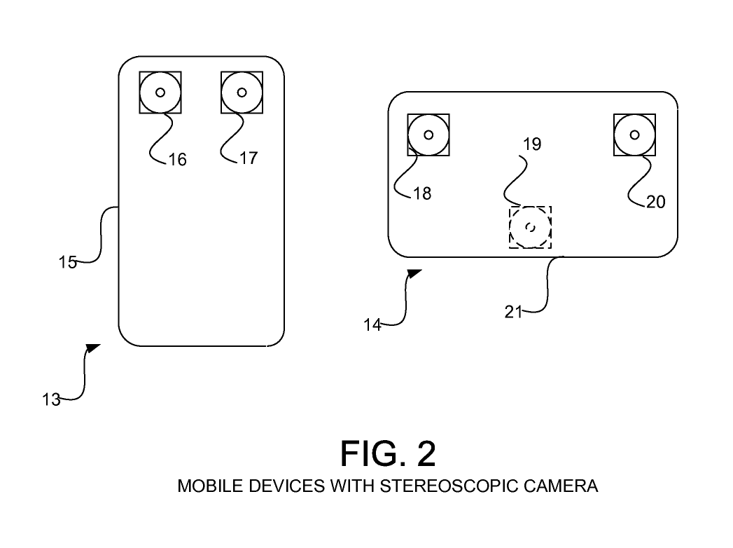

FIG. 2 illustrates various embodiments of the present invention. More specifically, FIG. 2 illustrates incorporation of more than one image sensor onto a consumer device to provide stereoscopic capture capabilities as described herein.

In one embodiment, a consumer device 13, such as a mobile telephone, personal media player, mobile internet device, or the like includes two imaging sensors 16 and 17 coupled to body 15. In various embodiments, imaging sensors 16 and 17 are configured to acquire left and right 2D image pairs at substantially the same time (e.g. within a second or less). In various embodiments, stereoscopic cameras 16 and 17 may be embedded directly into consumer device 13, and imaging sensors 16 and 17 may have a fixed position and orientation with respect to body 15. In other embodiments, imaging sensors 16 and 17 may be movable within body 15 (e.g. along a track or point of rotation) or may be removable from body 15.

In various embodiments, cameras 16 and 17 may be affixed at a known displacement (e.g. offset or location) relative to each other. In other embodiments, the displacement between cameras 16 and 17 may be modified by the user and the displacement may be determined by consumer device 13. In various embodiments, cameras 16 and 17 may alternatively capture left and right 2D images or videos or simultaneously capture such images at any other speed fast enough to approximate simultaneity.

The acquisition of such images may be initiated by the user via software and/or hardware portions of consumer device 13. For example, the acquisition may be initiated via depression of a physical switch or the selection of a “soft” button on a display of the consumer device 13. In such embodiments, executable software code stored within a memory in consumer device 13 may instruct one or more processors within consumer device 13 to acquire at least a pair of images from image sensors 16 and 17 and to store such images into a memory.

In various embodiments, the acquired left and/or right images may be displayed to back to the user on a display of consumer device 13. Additionally, the left/right images may processed by the one or more processors for display as a stereoscopic image pair. In various examples, the images may be combined into a static stereoscopic image, and when a lenticular lens (e.g. prismatic) is disposed on top the display, the user may simultaneously see the left/right images with their respective left/right eyes. Such a lenticular lens may be provided in various embodiments of the present invention, in the form of a removable sheet the user places over a display of the consumer device to view 3D images. In other embodiments, the lens may be part of a removable sleeve the user slips onto the consumer device to view 3D images.

In other embodiments, the left/right images may be uploaded to another consumer device, such as a laptop, desktop, cloud storage system, television, HD monitor, or the like. In such embodiments, the right/left images may be displayed on a display in a time-interleaved manner and viewed by the viewer, as described in the co-pending patent application referenced above.

In various embodiments, in addition to the left/right image pairs, the relative position of cameras 16 and 17 to each other, the position of cameras 16 and 17 relative to the display, the optical settings and characteristics of cameras 16 and 17 may also be recorded in the memory and/or referenced. Such parameters or settings may be made available to various processing software (resident upon consumer device 13, or other processing device) to further deduce, capture, or process information from cameras 16 and 17. As merely an example, based upon displacement between cameras 16 and 17, estimates of distances and other measurements may be performed in three-dimensions. As another example, parameters or settings may include camera parameters, e.g. shutter speed, aperture, gain, contrast, and the like may be measured from a left camera and be applied to the right camera to normalize the captured left/right 2D images.

In various embodiments, consumer device 13 may be vertically oriented when acquiring a left/right images. In still other embodiments, a consumer device may be horizontally oriented when acquiring left/right image pairs. An example of this is illustrated by consumer device 14 (e.g. mobile phone) in FIG. 2, where cameras 18 and 20 are distributed along the long axis of device 21. As described above, image sensors 18 and 20 may capture right/left images at substantially the same time (or the like) to enable the generation/viewing of stereoscopic images.

In various embodiments of the present invention, one or more additional image sensors, such as camera 19 may be provided as part of the consumer device. In the embodiment illustrated in FIG. 2, camera 19 may be directed towards the user, while cameras 18 and 20 are directed away from the user. Such embodiments may be provided to capture not only a right/left image pair, but a reaction of the user. As an example, the user may use consumer device 13 to record a video of a roller coaster ride in “3D” and to contemporaneously record their reactions. In still other embodiments, camera 19 may be installed or rotated such that cameras 18, 19 and 20 are all pointed in approximately the same direction, toward the same plane, line, or the like, towards or away from the user, or the like. In various embodiments, display of consumer device may also be directed towards or away from the user. In various embodiments, images and camera parameters captured by cameras 18-20 may also be used as a source of stereoscopic image data, such as for 3D scene reconstruction, or the like.

In other embodiments of the present invention, the consumer device may include one or more segments which move with respect to each other such that the stereoscopic cameras remain horizontally oriented (e.g. level) while the display or other sections of the consumer device are rotated or manipulated. In various embodiments, the cameras may be manually leveled by the user to be horizontal disposed, and in other embodiments, the cameras may be automatically manipulated by the consumer device via feedback from one or more tilt sensors or accelerometers provided in the consumer device.

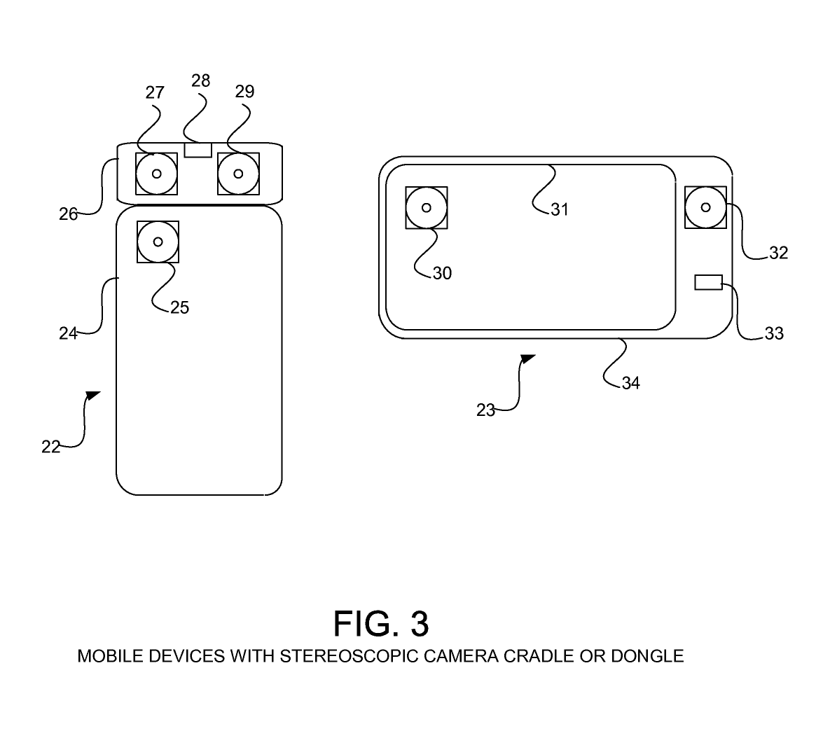

FIG. 3 illustrates embodiments of the present invention directed towards supplementing consumer devices having an image sensor with right/left image acquisition capabilities. In particular, FIG. 3. illustrates embodiments where stereoscopic image capture capabilities can be added to an existing consumer device (e.g. mobile phone) by means of an external cradle, dongle, or other device.

In various embodiments illustrated in FIG. 3, a consumer device 22 includes a body portion 24 coupled to a dongle 26. Dongle 26 may include one or more image sensors, such as cameras 27 and 29. In various embodiments, dongle 26 provides image data, camera parameter data, or the like to consumer device 22 via a physical and/or data communications channel, such as USB or microUSB connector, wireless (e.g. IR, Bluetooth, Wi-Fi, ZigBee radio (ZigBee Alliance), IEEE Standard 802.15.4, IEEE Standard 802.15.1), docking (e.g. iPod connector), a proprietary connector, or the like. In other embodiments, any other method for physically restraining dongle 26 with respect to consumer device 22 is contemplated, additionally, any other transfer protocol for providing data from dongle 26 to consumer device 22 is also contemplated.

In embodiments of the present invention, a user may initiate capture of right/left images on dongle 26 via one or more physical buttons on dongle 26 or consumer device 22 or soft buttons on a display of consumer device 22. Similar to the embodiments described above, executable software code operating upon consumer device 22 may direct a processing device within consumer device 22 or dongle 26 to initiate acquisition of images by cameras 27 and 29. It is contemplated that consumer device 22 may send one or more instruction signals to dongle 26 via the same physical and/or data communications channel as described above. Alternatively, other communications methods and mechanisms for instructing dongle 26 are contemplated.

In response to the user or to the consumer device 22, in various embodiments, dongle 26 initiates the capturing of one or more images from image sensors 27 and 29. Additionally, dongle 26 may capture image parameters from one or both of image sensors 27 and 29 to assist in capturing, normalizing, and/or generating of stereoscopic images. In various embodiments, such information may include the fixed or relative locations of cameras 27 and 29, optical parameters (e.g. aperture, shutter speed, focal length, iso, focal point in the images, and the like), level or orientation information from tilt sensor 28, and the like. In various embodiments of the present invention, consumer device 22 may include functionality described above for dongle 26, such as tilt sensor 28, or the like.

In various embodiments, dongle 26 may be capable of using more than one communication protocol and may connect to other devices than consumer device 22. For example, dongle 26 may provide right/left images directly to other users' mobile phones, computers, televisions, or the like, via Bluetooth, Wi-Fi, ZigBee radio, IEEE 802.15.1, IEEE 802.15.4, IR, or the like. In various embodiments, dongle 26 may communicate with such devices either one at a time, in an interleaved manner, simultaneously, or the like.

FIG. 3 also illustrates additional embodiments of the present invention. More particularly, a consumer device 23 is illustrated including an external device such as cradle 34 physically holding or enveloping the body 31 of consumer device 23. In the embodiments illustrated, cradle 34 includes a single image sensor 32, although in other embodiments, more than one image sensor may be provided. In the embodiments illustrated, cradle 34 is operated such that the image sensor 30 of consumer device 23 operates in coordination with image sensor 32 to capture right/left image pairs.

In various embodiments, cradle 34 may be physically coupled to consumer device 23, as illustrated, or may be physically coupled in any manner contemplated or described in the embodiments above (e.g. iPod connector, USB). As illustrated in FIG. 3, consumer device 23 is placed into an undersized opening of cradle 34, and thus consumer device 23 and cradle 34 are physically restrained with respect to each other. Further, cradle 34 and device 23 may communicate image data, sensor data, instructions to and from consumer device 23 in any manner described in the embodiments above (e.g. Bluetooth, Wi-Fi, IR).

As previously described, additional camera information such as camera parameters and/or information from a tilt sensor 33 maybe determined by cradle 34. In various embodiments, cradle 34 may also communicate such information about the optical characteristics and properties of image sensor 32 to consumer device 23. Such data may be used by consumer device 23 to coordinate the actions of image sensors 30 and 32. As an example, in various embodiments of the present invention, camera or lens parameters from image sensor 32 may be used to set the parameters of image sensor 30. As examples of this, a gain setting from image sensor 30 may be used to set a gain setting of image sensor 32, a shutter speed of image sensor 32 may be used to set a shutter speed of image sensor 30, and the like.

In light of the above, it can be seen that in various embodiments of the present invention, by providing a second image sensor to a consumer device that already includes a single image sensor, such a combined system may have some or all of the capabilities of an expensive and dedicated stereoscopic image capture system, as previously discussed.

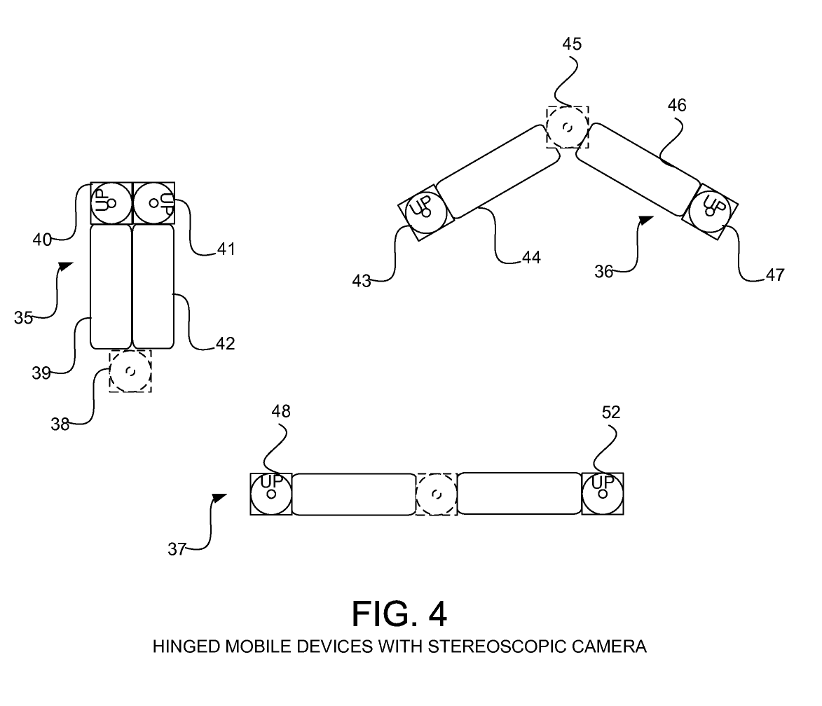

FIG. 4 illustrates various embodiments of the present invention. In particular, a consumer device 35 is illustrated including two sections 39 and 42 and at least a pair of image sensors 40 and 41. In FIG. 4, section 35 and 42 are coupled together by a hinge or other conveyance. In various embodiments, consumer device 35 may be “folded-up”, or consumer device 36 may be partially opened, consumer device 37 may be fully opened, or the like, as shown. As can be seen, depending upon the amount a hinge is opened, the displacement between sensors may vary. For example, for consumer device 36, image sensor 43 is disposed upon the side or end of section 44 and image sensor (e.g. camera) 47 is disposed upon the end of side or end of section 46. As shown, cameras 43 and 47 are laterally displaced with respect to each other; in another case image, sensor 40 is adjacent to 41; and in another case, cameras 8 and 52 are far away from each other.

As can be seen, in various embodiments, the orientation of the two cameras in terms of their distance relative to each other, their rotation relative to each other, the tilt of the entire system and the like, are variable. Because of this, in various embodiments, the displacements between the cameras, camera parameters, image parameters and the like may be recorded. As described in the various embodiments above, such data may be used for many purposes by the consumer device, external device (e.g. desktop computer), or the like, such as determining stereoscopic images, 3D image reconstruction, or the like.

In various embodiments, an additional image sensor, such as image sensor 45 may also be included and may provide all the benefits of more than two cameras described herein. The additional image sensors may be fixed or rotated such that the three cameras are pointed in the same direction (e.g. toward the same plane, line, or other geometric construction) such that stereoscopic information can be deduced for multiple orientations of the device, in opposite directions, or the like.

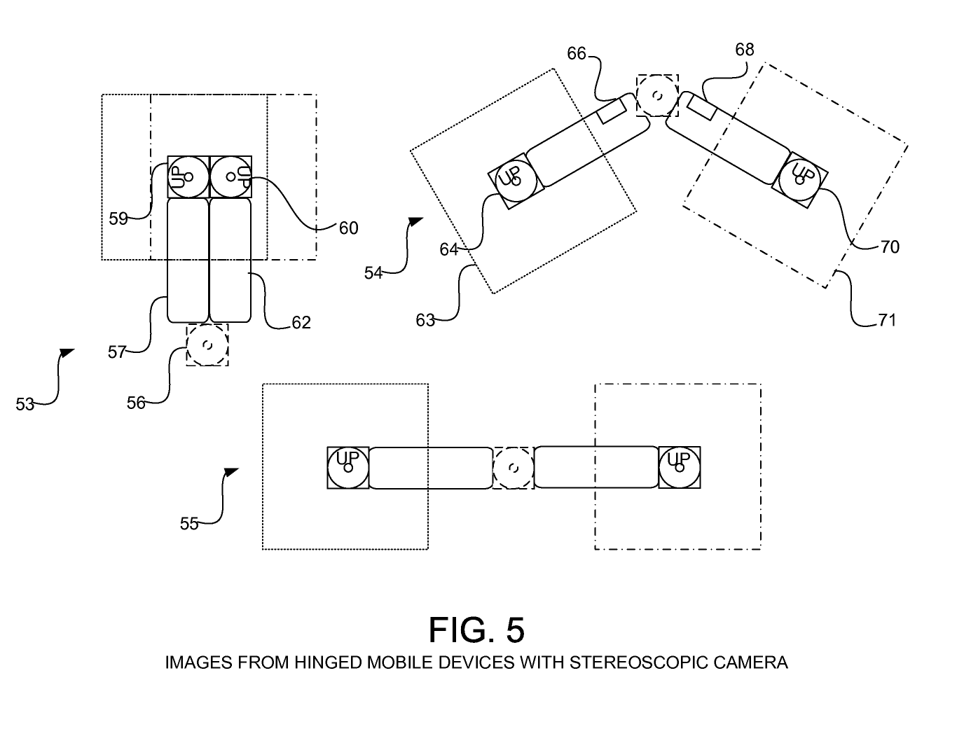

FIG. 5 illustrates additional features of embodiments of the present invention illustrated in FIG. 4. For example, a field of view 63 is shown for camera 64, a field of view 71 is illustrated for camera 70, and the like.

In various embodiments, it can be seen that cameras 59 and 60 that are adjacent in consumer device 57, are “pulled apart,” in consumer device 54, and cameras 64 and 70 are then separated and rotated relative to each other. In various embodiments, cameras 64 and 70 may remain in the same plane as they move, however they may also change plane with respect to each other.

In various embodiments, as cameras 64 and 70 rotate away from each other, tilt sensors 66 and 68 may be used to determine the tilt of each camera. These measurements may be referenced to determine a separation angle between cameras 64 and 70. Then, using the known geometry of the device, the linear displacement, or the like between cameras 64 and 70 can be determined. In various embodiments, such information may be deduced by other means, such as installing a single tilt sensor and directly measuring the angle of a hinge 67, by deduction from the camera image data, or the like.

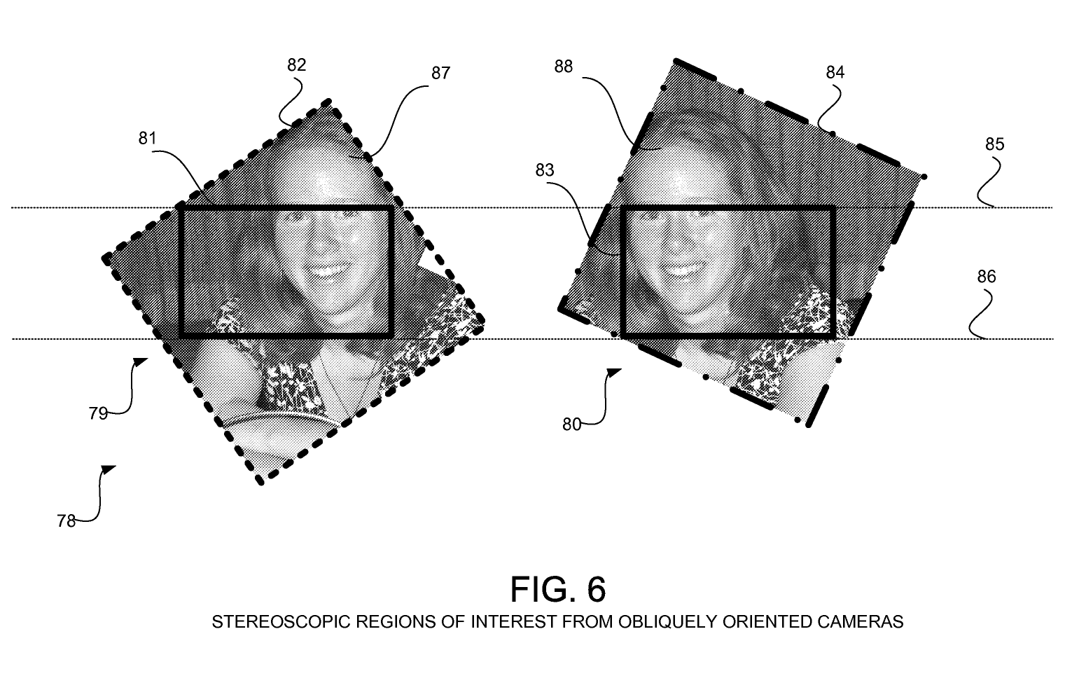

FIG. 6 illustrates an example of the result of various embodiments of the present invention. More particularly, FIG. 6 shows an example of image data 82 and 84 from two image sensors of a consumer device that have been separated by an arbitrary distance. In this example, image data 82 and 84 are rotated and tilted relative to each other as a result of being captured on a consumer device similar to cameras 64 and 70, in FIG. 5

In various embodiments, images captured by a user are expected to be rectangular in shape and parallel to the ground. Accordingly, rectangles 81 and 83 represent level rectangular image information available from image data 82 and 84. In FIG. 6, lines 85 and 86 illustrate that rectangles 81 and 83 are level. In various embodiments, rectangles 81 and 83 may be used to represent the right/left image pair for generating a stereoscopic 3D image.

In various embodiments, a consumer device 78 may display one or both of image data 81 and 83 to the user on a display as 2D images or as a 3D stereoscopic image, before or while acquiring or storing image and/or video data. In such embodiments, the user can be provided feedback as to how to reorient the image sensors with respect to each other, to capture the desired 2D image(s). The inventors have determined that if images 81 and 83 do not have sufficiently overlapping subject matter, or if images 81 and 83 have narrow fields of view, a stereoscopic image formed from images 81 and 83 will not convey a significant 3D effect to the viewer. The feedback from consumer device 78 may be provided in real-time to the user.

In various embodiments, consumer device 78 may provide feed back in the form of tilt sensor feedback, to encourage the user to hold the device such that both cameras are more level, as illustrated by consumer device 55 in FIG. 5. In practice, the inventors have determined that if the cameras are more level with respect to each other, the rectangular size of the region of interest increases. In other examples, face recognition technology can also be used, either to override or to coordinate with the tilt sensor, to increase or maximize the area of a face which is captured by images 81 and 83.

In various embodiments, the system can encourage the user to reorient the system manually or the system may be able to do so automatically. For example, consumer device 78 may increase the region of interest (e.g. image data 81 and 83) by encouraging the user to manually level the cameras with respect to each other; encouraging the user to manually open or close the hinge completely; encouraging the user to “zoom out,” pan upwards; etc. The inventors have determined that automatic zooming out or panning upwards are particularly useful if face recognition technology is also included. As an example, such techniques would be useful to prevent image 81 and 83 from cropping out the eyebrows of the person illustrated in FIG. 6.

In still other embodiments, stereoscopic 3D image data may be deduced without the need for multiple camera image capture systems, such as those shown in 13, 14, 22, 23, 35, 36 or 37 if the subject is still enough that the user can generate one image such as 82 and then translate or rotate the camera to produce another image such as 84. If the subject is not sufficiently still, multiple images can still be used to deduce the stereoscopic data that is correct for a particular image.

In various embodiments, a graphical display similar to the one shown in 78 may be displayed to the user, either as a flat (e.g. 2D) or stereoscopic 3D image. The consumer device may then provide the user with information which allows the user to translate or rotate the camera of the consumer device into a new position to take another image. In such embodiments, the multiple images from a single camera may substitute for a set of single images from multiple cameras. In various embodiments, the consumer device determines the above-mentioned horizontal region of interest on the first image and displays information to guide the user in taking the next picture, to increase the 3D overlap or effect.

In various embodiments, the user may be given written, verbal, or other instructions to take both pictures. Such embodiments can also assist the user in taking the first image offset to one side instead of centered. This allows the second image to be offset to the other side, the result of which is the subject is centered in the deduced stereoscopic 3D image. An example of such instructions is “Take a picture with the left eye on the viewfinder, then move the camera such that the right eye is on the viewfinder and take another picture.” With such embodiments, the feedback that the user has generated both images appropriately can be provided after both images are taken and after the resulting stereoscopic 3D image is determined. In some embodiments, the camera image data is examined to provide the user with graphical feedback to assist the user in capturing the second image. In such examples, the user is presented with a display, audible or other information to help select the second image after the first image has been taken. In some embodiments facial recognition technology may be useful to encourage the user to translate the entire camera such that a stereoscopic image data of an entire face can be ensured, as opposed to a stereoscopic 3D image of landscape or still life, for example

In light of the above disclosure, one of ordinary skill in the art would recognize that many variations may be implemented based upon the discussed embodiments. Embodiments described above may be useful for hand-held consumer devices such as cell-phones, personal media players, mobile internet devices, or the like. Other embodiments may also be applied to higher-end devices such as laptop computers, desktop computers, digital SLR cameras, HD video cameras, and the like.

In various embodiments of the present invention, the dongle described above may be operated to acquire 2D images when semi-permanently affixed to a consumer device. In other embodiments, the dongle may be operated to acquire 2D images apart from the consumer device. Subsequently, the 2D images may be provided to the consumer device using one or more of the transmission protocols described above. In such embodiments, the dongle may be stored semi-permanently affixed to consumer

The above detailed description is directed to systems, methods, apparatus and computer-readable media for stereoscopic image capture. While the subject matter described herein is presented in the general context of hardware blocks that are embedded in electronic devices or program modules that execute in conjunction with the execution of an application program or an operating system on a computer system, consumer electronics device, or an information processing device, those skilled in the art will recognize that other implementations may be performed in combination with other program modules or devices.

Further embodiments can be envisioned to one of ordinary skill in the art after reading this disclosure. In other embodiments, combinations or sub-combinations of the above disclosed invention can be advantageously made. The block diagrams of the architecture and flow charts are grouped for ease of understanding. However it should be understood that combinations of blocks, additions of new blocks, re-arrangement of blocks, and the like are contemplated in alternative embodiments of the present invention.

The specification and drawings are, accordingly, to be regarded in an illustrative rather than a restrictive sense. It will, however, be evident that various modifications and changes may be made thereunto without departing from the broader spirit and scope.

What is claimed is:

1. A consumer device for capturing stereoscopic images comprising:
a plurality of image acquisition devices, wherein a first image acquisition device and a second image acquisition device are both approximately directed in a common direction, wherein the first image acquisition device and the second image acquisition device are displaced by a displacement, wherein the first image acquisition device is configured to capture a first image, and wherein the second image acquisition device is configured to capture a second image;
a user input device configured to receive an input from a user;
a memory configured to store the first image and the second image;
a wireless communications portion configured to transmit data to a remote device; and
a processor coupled to the first image acquisition device, to the second image acquisition device, to the user input device, and to the wireless communications portion, wherein the processor is configured to approximately contemporaneously direct acquisition of the first image by the first image acquisition device and of the second image by the second image acquisition device in response to the input from the user, wherein the processor is configured direct storage the first image, the second image, and the displacement in the memory, and wherein the processor is configured to direct the wireless communications portion to transmit at least a portion of the first image and at least a portion of the image to a remote device.

2. The consumer device of claim 1 wherein the displacement is selected from a group consisting of: a user-modifiable displacement, a fixed displacement.

3. The consumer device of claim 1 further comprising
a removably attached portion, wherein the removably attached portion includes at least the first image acquisition device, and wherein the removably attached portion is configured to communicate the first image to the memory via a communications channel.

4. The consumer device of claim 3 wherein the communications channel is selected from a group consisting of: Bluetooth, infrared, Wi-Fi, ZigBee radio, IEEE 802.15.1, IEEE 802.15.4, a serial data bus.

5. The consumer device of claim 1 wherein the removably attached portion is selected from a group consisting of: a dongle, cradle, an attachment, an encasement.

6. The consumer device of claim 1
wherein the processor is also configured to determine at least a tilt of the first camera with respect to level; and
wherein the processor is configured to determine the portion of the first image in response to the tilt of the first camera.

7. The consumer device of claim 1
wherein the processor is configured to determine the portion of the first image by being configured to perform manipulations on the first image to determine the portion of the first image,
wherein the processor is configured to determine the portion of the second image by being configured to perform manipulations on the second image to determine the portion of the second image,
wherein the manipulations are selected from a group consisting of: image rotation, image crop, image scale, perspective correction.

8. The consumer device of claim 1
wherein the processor is configured to determine locations of faces within the first image;
wherein the processor is configured to determine locations of the faces within the second image;
wherein the processor is configured to determine the portion of the first image in response to the locations of the faces within the first image; and
wherein the processor is configured to determine the portion of the second image in response to the locations of the faces within the second image.

9. The consumer device of claim 1
wherein the processor is configured to determine a first set of camera parameters associated with the first image acquisition device; and
wherein the processor is configured to set a first set of camera parameters associated with the second image acquisition device, in response to the first set of camera parameters.

10. The consumer device of claim 8 wherein the first set of camera parameters are selected from a group consisting of: shutter speed, aperture, focal length, position in interest, iso, gain, offset, brightness, contrast,

11. A method for capturing stereoscopic images, photos or videos on a mobile computing device, wherein the mobile computing device includes at least a first camera and a second camera, and wherein a distance and an orientation between the first and the second cameras are determinable, the method comprising:
receiving an initiation signal from a user, while the user points the first and the second cameras in a direction of interest;
substantially simultaneously acquiring a first image with first camera, a second image with a second camera and camera parameters, in response to the initiation signal;
storing the first image, the second image and the camera parameters in a memory; and
uploading at least a portion of the first image, at least a portion of the second image, and the camera parameters to a remote server.

12. The method of claim 11
wherein the mobile computing device comprises a mobile telecommunications device; and
wherein the first and the second cameras of the computing device are embedded into the mobile telecommunications device.

13. The method of claim 11 further comprising:
removably coupling a device to the mobile computing device, wherein the first camera and the second camera are embedded in the device;
wherein the sensor device is selected from a group consisting of: a dongle, an encasement device, an attachment.

14. The method of claim 11 further comprising:
determining a tilt orientation of the first camera; and
performing manipulations on the first image to determine the portion of the first image in response to the tilt orientation;

15. The method of claim 11 further comprising:
changing the distance and the orientation between the first camera and the second camera in response to a physical manipulation of the mobile computing device by the user.

16. The method of claim 15 further comprising determining the distance and the orientation between the first camera and the second camera with one or more sensors in the mobile computing device.

17. The method of claim 11 further comprising:
determining an initial portion of the first image and an initial portion of the second image;
determining suggested manipulations of the mobile computing device to increase a size of the initial portion of the first image; and
outputting the suggested manipulations of the mobile computing to the user.

18. The method of claim 17 further comprising:
repositioning the first camera relative to the second camera in response to physical manipulations by the user;
receiving another initiation signal from the user, while the user points the first and the second cameras in the direction of interest;
substantially simultaneously acquiring a third image with the first camera, a fourth image with the second camera and additional camera parameters, in response to the other initiation signal;
storing the third image, the fourth image and the additional camera parameters in the memory; and
wherein uploading at least a portion of the first image, at least a portion of the second image, and the camera parameters to a remote server comprises uploading at least a portion of the third image, at least a portion of the fourth image, and the additional camera parameters to the remote server.

19. The method of claim 11 further comprising:
determining a location of a face in the first image;
determining a location of the face in the second image; and
determining manipulations of the first camera relative to the second camera such that the location of the face is within the portion of the first image and that the location of the face is within the portion of the second image.

20. The method of claim 19 further comprising:
automatically performing the manipulations on the first camera relative to the second camera;
receiving another initiation signal from the user, while the user points the first and the second cameras in the direction of interest;
substantially simultaneously acquiring a third image with one camera, a fourth image with the second camera and additional camera parameters, in response to the other initiation signal;
storing the third image, the fourth image and the additional camera parameters in the memory; and
wherein uploading at least a portion of the first image, at least a portion of the second image, and the camera parameters to a remote server comprises uploading at least a portion of the third image, at least a portion of the fourth image, and the additional camera parameters to the remote server.
